(19) United States
(12) Patent Application Publication
(10) Pub. No.: US 2016/0085770 A1
(43) Pub. Date: Mar. 24, 2016

(54) SYSTEM AND METHOD OF DIGITAL IMAGE MATCHING WITH SUBJECT DESCRIPTORS

(71) Applicant: ImageQuix, Inc., Greenville, SC (US)

(72) Inventor: Mark Valente, Greenville, SC (US)

(73) Assignee: ImageQuix, Inc.

(21) Appl. No.: 14/494,773

(22) Filed: Sep. 24, 2014

(51) Int. Cl. G06F 17/30; H04L 29/08

(52) U.S. Cl. CPC G06F 17/30174; G06F 17/30268; H04L 67/1095

(57) ABSTRACT

This invention is directed to a system for associated digital images with digital image subjects comprising: a personal computing device in wireless communications with a server that, when actuated by a photographer, receives gallery selection input, captures a sync timestamp and receives a plurality of subject descriptor inputs wherein each subject descriptor input has a unique timestamp; a digital camera for capturing a plurality of digital images and a server having computer readable instructions stored in the server for: receiving digital images and the sync timestamp, determining an adjustment factor between the sync timestamp and the timestamp of the sync digital image, adjusting the timestamp of a digital image by the adjustment factor, and associating the digital image with a first subject descriptor when the adjusted timestamp of the digital image falls between the time stamp of a first subject descriptor and a second subject descriptor.

### FIELD OF THE INVENTION

This invention is directed to a system and method for providing real time subject descriptors associated with a photographic subject, to a server located remotely from a photographic session, subsequently transmitting digital images to the server from the photographic session and matching the subject descriptors to the digital images.

### BACKGROUND

The tradition of the school photo has been around since at least the early 1930s. Organizing and taking school photos is a logistically intensive process from the gathering of the identification data of the photo subjects, to taking the images, to distributing these to schools, yearbooks as well as the individuals themselves. The business model that has developed over the years includes one where the photographer generates revenues by providing the photographic service for little to no fee but offers the images themselves to the students, or more accurately, the students' parents with a fee.

With the advent of digital photography, the photographer can upload images to a website, allow the potential purchaser to view his or her image and purchase either digital or electronic images. One challenge in this process is to relate the actual digital images taken with identification information of the subject. Traditionally, several methods were employed to provide sufficient information to match the image with identification information so that in a subsequent process, the photographer can match the images with the subject information.

For example, students could hold a sign or paper with their name, grade and class for the first image taken so that the photographer can simply review the first image of the set for that subject and receive the identification information. This process requires a significant amount of time in that each photograph has to be reviewed and associated with the subjects information. In an alternative process, a list of the students (photographic subjects) are provided to the photographer. The students are placed in line and in order as shown in the list. The images are taken in the same order as that of the list. Subsequently, the photographer reviews the images and associates the images with the subject's information with the assumption that the images are in order of the list. This process has significant disadvantages in that if the photographic subjects are out of order then it is virtually impossible to associate the subject's information with the images. The photographic subject can become out of order if they physically move in the line or one is absent.

With the traditional methods of matching names with images, automating the process was challenging at best. For example, automatically to match the list of names with the images through a computer method would require some additional step or limitation. In one case, the photographer would take a fixed number of images per subject, (e.g. two and only two) so that each name on the list would be associated with the predetermined number of images. Alternatively, a computer system could use facial recognition technology to match images and associate like images with the subject's information. Neither method is desirable.

### BRIEF DESCRIPTION OF THE DRAWINGS

The invention is further described in reference to the following drawings which are incorporated by reference.

FIG. 1 is a schematic of components of the invention;

FIG. 2A through 2C are diagrams of aspects and the operation of the present invention; and,

FIGS. 3 through 5 are flowcharts of the present invention.

### SUMMARY OF THE INVENTION

The construction designed to carry out the invention will hereinafter be described, together with other features thereof. The invention will be more readily understood from a reading of the following specification and by reference to the accompanying drawings. The objects of the invention are accomplished by providing a system for associating digital images with digital image subjects comprising: a server having a server computer readable medium and processor in electronic communication with a portable computing device; a subject database having a set of subject descriptors stored on the server computer readable medium wherein each subject descriptor represents a unique subject to be photographed; and, a set of server computer readable instructions stored on the service computer readable medium that when executed by the server's processor: receives the set of subject descriptors, populates the database with the list of subject descriptors, receives a gallery identifier, associates the gallery identifier with the set of subject descriptors, transmits a list of gallery identifiers to the portable computing device, receives a gallery identifier selection from the portable computing device, retrieves the set of subject descriptors from the subject database, transmits the set of subject descriptors from the subject database to the portable computing device, receives a camera label from the portable computing device, receives a sync timestamp from the portable computing device, receives a plurality of subject descriptors each having a timestamp, receives a sync digital image having a digital image sync timestamp wherein the sync timestamp and the sync digital image are created contemporaneously, receives a set of images from a photographer's computer in electronic communications with the server where in each image includes a timestamp, determines a temporal adjustment factor representing the difference between the sync timestamp and the timestamp of the sync digital image and associates a digital image with a first subject descriptor if the adjusted timestamp of the digital image falls between the timestamp of the first subject descriptor and a second subject descriptor.

The sync timestamp and the sync digital image can be created simultaneously. The set of server computer readable instructions can include instructions for starting a new session upon receiving a request from a remote portable computing session, associating the camera label with the session, associating the sync timestamp with the session, associating the set of subject descriptors with the session and associating the digital images with the session. The server can receive the plurality of subject descriptors, each having a timestamp, in a linear fashion in real time or this information can be sent to the server in batches or after all the information has been captured.

The set of server computer readable instructions can includes instructions that display a portion of the invention from each subject descriptor and the associated digital images on a website accessible through a global communications network. The set of server computer readable instructions can includes instructions for receiving image selection information from a user accessing the website identifying a digital image and transmitting the digital image to a print fulfillment service so that the use can be provided a physical copy of the digital image. The subject descriptors can be organized and displayed by gallery identifiers. A camera label can be associated with a camera and ultimately with a gallery.

In one embodiment, the sync digital image is an image taken with the lens cap on providing for a black image, and the set of server computer readable instructions includes instructions for identifying a black digital image as the sync digital image.

The invention can include a personal computing device (such as a smart phone) having computer readable instructions so that when the personal computing device is actuated by a photographer, the personal computing device displays at least one gallery receiving a gallery selection input, receives a camera label, captures a sync timestamp, displays a plurality of subject descriptors, receives a subject descriptor input, wherein each subject descriptor input has a unique timestamp, and transmits the gallery selection input, camera label, sync timestamp and plurality of subject descriptors to a server; a digital camera for capturing a plurality of digital images, including a sync digital image, each having a timestamp that can be uploaded to the server; and, a set of server computer readable instructions stored on the server for: receiving the gallery selection input, camera label and sync timestamp, receiving the digital images, determining an adjustment factor representing the difference between the sync timestamp and the timestamp of the sync digital image, adjusting the timestamp of a digital image by the adjustment factor, associating the digital image with a first subject descriptor when the adjusted timestamp of the digital image falls between the time stamp of a first subject descriptor and a second subject descriptor, displaying a portion of information from each subject descriptor, displaying the digital images associated with the subject descriptor on a website accessible through a global communications network, receiving image selection information from a user accessing the website identifying a digital image and transmitting the digital image to a print fulfillment service so that the use can be provided a physical copy of the digital image.

The set of server computer readable instructions stored on the server for verifying that payment has been made for the print prior to transmitting the digital image to the print fulfillment center. Contact information can be included in the subject descriptor and the set of server computer readable instructions includes instructions for transmitting a notification to an individual associated with the contact information informing the individual that the digital images are available for viewing and physical goods having the image can be requested.

The set of server computer readable instructions can include instructions for transmitting a notification to an individual associated with the contact information informing the individual that the physical goods have been created.

### DESCRIPTION OF THE INVENTION

Computer readable instructions, when executed by a computer processor, cause the computer to perform a series of steps to accomplish a specific task and resulting in useful, concrete and tangible results. This computer readable code is tied to a particular machine or apparatus with the specific purpose of executing the computer readable code for accomplishing tangible results and represents and accomplishes the manipulation of physical data.

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result, when executed by a computer and its processor representing or resulting in the tangible manipulation of physical objects. These steps also require physical manipulations of physical quantities such as electrical or magnetic physical elements and are capable of being stored, transferred, combined, compared, or otherwise manipulated readable medium that is designed to perform a specific task or tasks. Actual computer or executable code or computer readable code may not be contained within one file or one storage medium, but may span several computers or storage mediums. The term “host” and “server” may be hardware, software, or a combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or codes.

Elements of the flowchart support combinations of means for performing the special functions, combination of steps for performing the specified functions and program instruction means for performing the specified functions. It will be understood that each block of the flowchart illustrations can be implemented by special purpose hardware-based computer systems that perform the specified functions, steps, or combinations of special purpose hardware or computer instructions.

The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough and complete and will fully convey the scope of the invention to those skilled in the art.

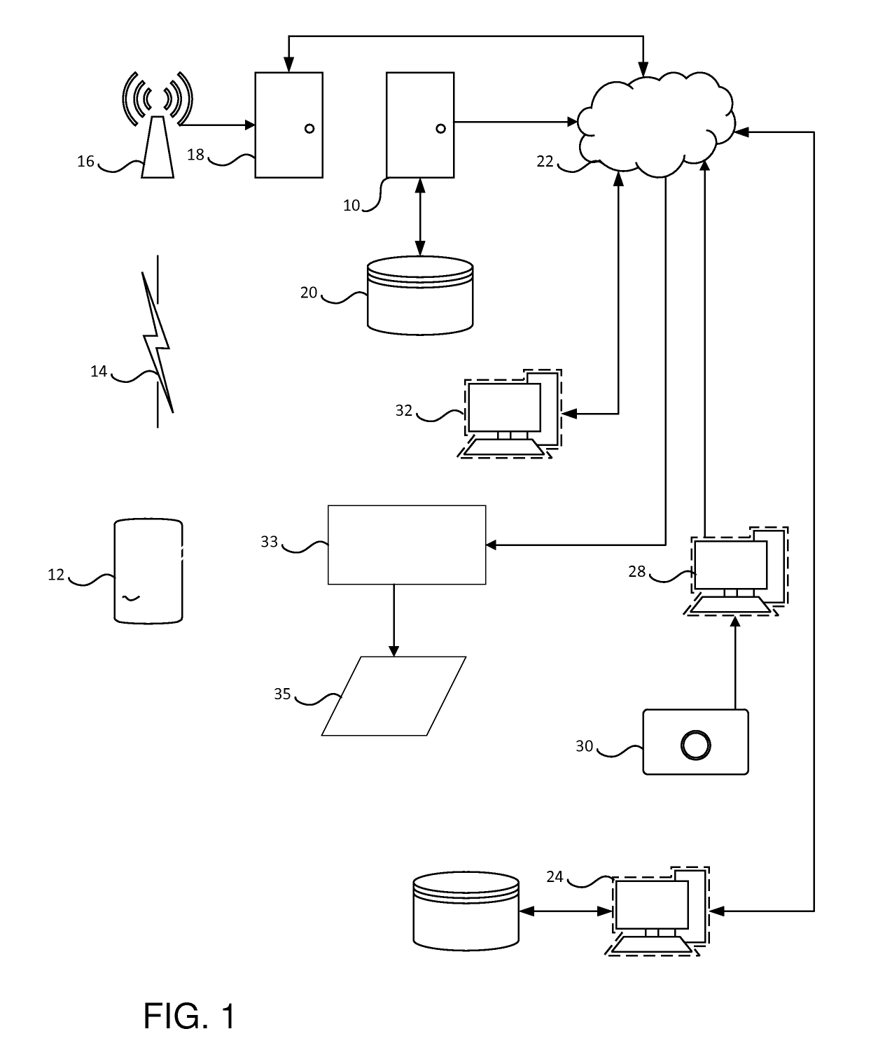

Referring to FIG. 1, a server 10 has a computer readable medium and a processor. The service is in electronic communication 14 with a portable computing device having a processor and computer readable instructions such as a smart phone 12 through a wireless network such as a cellular network. The wireless network can include an access point 16 that is connected to a wireless server 18 which in turn can be connected to the server. With this configuration, the smart phone can be in real time communications with the server and can transmit and receive digital information to and from the server in real time. The wireless server and the server can be connected through a wide area network 22 such as a global communications network. The smart phone can include a processor, digital storage, camera and display.

A subject database 20 can be included in the server computer readable medium or can be stored remotely from the server and in communications with the server. The database can include a set of records that are subject descriptors that represent subjects that are to be photographed. For example, the subject descriptors can include a unique subject identifier, name, school, grade, teacher, and the like. The unique identifier can be a computer readable symbol, barcode, QR code or alpha numeric text.

The server can include a set of computer readable instructions stored on the server computer readable medium that when executed by a processor included with the server receives a list of the subject descriptors from a third party such as a school. The third party can use a remote computer 24 connected to the wide area network to send the list of subject descriptors to the server. For example, a school can send a list of the students attending the school so that subjects for photographs are provided to the photographer prior to the photographer arriving at the school to take the photographs. In one embodiment, the subject descriptors can be uploaded in a database or dataset format 34. When the server receives lists of subject descriptors, the server can populate a subject database with the list of subject descriptors. The particular list can be identified by school, grade, teacher and the like. Further, the photographer can determine the number of sessions or cameras that will be needed based upon the volume of photographs that are needed to be taken. A gallery can be defined and identified with a gallery identifier and also associated with a list of subject descriptors. For example, a gallery can be all the students in a school. In one embodiment, information that can be associated with a gallery includes the gallery identification which can be alpha numeric text, date the gallery was created, the status of the gallery (active or inactive), password to access the gallery, keywords associated with the gallery, the number of images contained within the gallery, the number of times the gallery was viewed and the number of different subjects contained in the gallery. The gallery descriptors or gallery name or gallery identification can be transmitted to the smart phone so that the photographer can select the gallery to be associated with the photography session.

In one embodiment, the subjects in the gallery can be listed. For example, the name of the students can be listed that are associated with the selected gallery and displayed on the smart phone. Further, information such as who has ordered images from the gallery and the amount that has been received for each order can be displayed on the smart phone.

During a photographic session, the photographer uses the smart phone and executes computer readable instructions located on the smart phone. The computer readable instructions can allow the photographer to log in with a unique photographer identification. The photographer identification can be transmitted to the server and authenticated.

The photographer can then select a new session from the smart phone indicating that a new photographic session is desired. The photographer can then provide a camera label to identify a digital camera that will be associated with the session. The camera label can be an alpha numeric text. The camera label can be transmitted to the server.

The server can transmit gallery identifiers, and other gallery information, from the server to the smart phone that is associated with the particular photographer. The smart phone can then display the list of galleries to the photographer and the photographer can select which gallery to work with for the particular photography session. When the gallery is selected by the photographer, the gallery identifier can be transmitted to the server so that the server is provided the information to determine which gallery the photographer is working with.

With the gallery information, the server can transmit the subject descriptors to the smart phone and the list of subjects can be displayed on the smart phone to the photographer.

In one embodiment, a sync step of preformed. In this step, the photographer actuates the smart phone to create a sync timestamp while simultaneously taking a picture with the lend cap on the camera. The sync timestamp can be transmitted to the server.

The next step, the photographer will capture the subject identification of the first photographic subject. In one embodiment, the subjects are provided with an identifier that can be alpha numeric text, barcode, QR code, number and the like. The subject descriptor is included in the subject descriptors. The smart phone can capture the subject descriptor through the smart phone camera or other input from the photographer. For example, the subject can present a subject descriptor to the photographer and the subject descriptor is captured by the smart phone. The smart phone can retrieve the subject's name from the subject descriptors associated with the subject descriptor and display the name to the photographer so that the photographer can verify that the subject physically has the proper subject descriptor. The subject descriptor can be transmitted to the server when verified. If the subject descriptor is not correct, the subject descriptor can be corrected and captured by the smart phone again and transmitted to the server. Once the subject descriptor is captured, the photographer can then take digital images of the subject.

When the photographer wishes to move to the next subject, the photographer captures the next subject descriptor and takes digital images of the next subject. These steps are repeated until a termination event occurs such as all subjects are taken. When the session is ended as can be indicated by the photographer on the smart phone, the smart phone can display the gallery information and the number of subjects that were captured. This can assist the photographer with insuring that all subjects were captured. In one embodiment, the subject indicators, and their respective timestamps, are stored on the smart phone and are not uploaded to the server until the session is ended. In one embodiment, the subject indicators cannot be uploaded until the session is associated with a gallery.

The photographer can then upload the images to the server using the photographer's computer 28. A media card that is removable from the camera can be inserted into the photographer's computer and the images transmitted to the server. In one embodiment, the camera 30 can be connected to the photographer's computer to transmit the digital images to the server.

When transmitting the images to the server, the photographer is presented with a list of galleries associated with that photographer. The photographer selects the desired gallery. The photographer is then presented with a camera label. The photographer selects the camera label associated with the camera used to take the digital images to be transmitted. Therefore, the digital images that are uploaded are associated with a gallery and camera. The server can then determine the proper set of subject indicators that have been previously uploaded that are to be associated with the set of digital images.

Once the digital images have been uploaded, the server's computer readable instructions retrieve the sync timestamp associated with the set of digital images and the timestamp of the sync digital image. An adjustment factor is calculated by determining the difference between the sync timestamp and the timestamp of the sync digital image. In one embodiment, the sync digital image can be analyzed and verified that it is a generally black image. For example, if the timestamp is in the format YYYY-MM-DDThh:mm:ss.sTZD where YYYY=four-digit year, MM=two-digit month (01=January, etc.), DD=two-digit day of month (01 through 31), hh=two digits of hour (00 through 23) (am/pm NOT allowed), mm=two digits of minute (00 through 59), ss=two digits of second (00 through 59), s=one or more digits representing a decimal fraction of a second and TZD=time zone designator (Z or +hh:mm or −hh:mm), the timestamp can be converted into POSIX time. When the sync timestamp and the sync digital image timestamp are converted into POSIX time, the difference between the two numbers is in seconds. Therefore, the difference between these two numbers could be the adjustment factors. The next step would be to determine the POSIX number associated with the first images and to adjust the timestamp of the first image by the adjustment factor. If the adjusted timestamp of the first image is equal to or greater than the timestamp of the first subject descriptor and less than the timestamp of the second subject descriptor, the digital image is associated with the first subject descriptor. By determining brackets defined by the time span between the timestamp of a subject descriptor and the timestamp of the subsequent subject descriptor and associating digital images that have adjusted timestamps in the brackets, the digital images can be associated with a subject descriptor. As this association is performed by the server, the photographer need only upload the images and associate the images with a gallery and camera and the images are automatically matched with a subject descriptor.

Subsequently, a user can access the server using user computer system 32 and retrieve the images associated with a subject descriptor. The user can then select to purchase prints of the selected images. In one embodiment, a fulfillment service 33 can transmit to the server various goods that can be purchased with the image. For example, photographs, cups, t-shirts, mouse pads, plaques, and the like. Each good can be associated with a price to provide to the purchasing individual. The individual can then purchase and pay for the good. Once the images are selected for purchase, the image can be transmitted by the server to the print fulfillment service where the image can be converted into a physical form 35 which can then be transmitted to the user.

In one embodiment, the server can use contact information contained in the subject descriptor and transmit a notification to the individual informing the individual that the digital images of the subject are ready for viewing. In one embodiment, the server or print fulfillment service can inform the individual that the physical good has been shipped. In one embodiment, the digital image is not transmitted to the fulfillment service until payment is received. Once payment is received, it can be transmitted by the server to an account designated by the photographer.

Therefore, this invention allows for digital images to be quickly and efficiently uploaded to the server, associated with subject descriptors and subject descriptors, made available for purchase, searched, purchased, transmitted to a print fulfillment or print shop without post-processing by the photographer. The photographer merely uploads the digital images and the information from the remote computing device (smart phone) and the remainder of the process is automated.

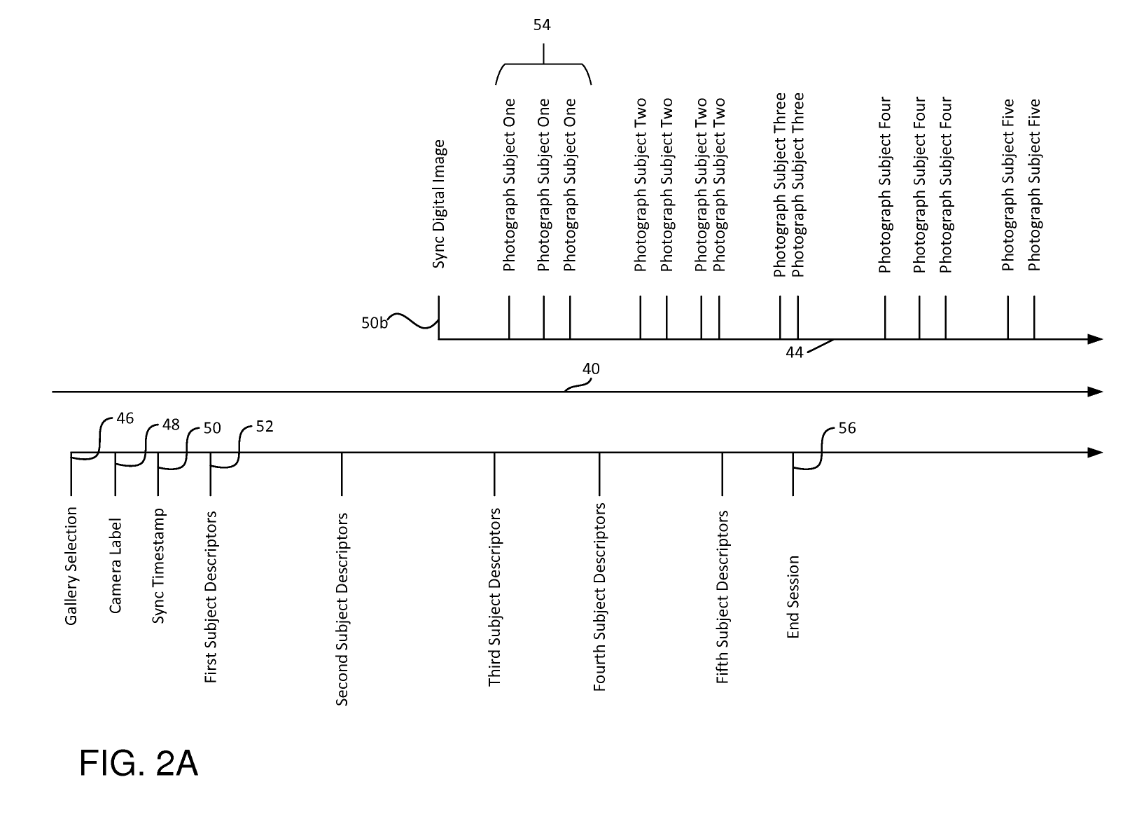

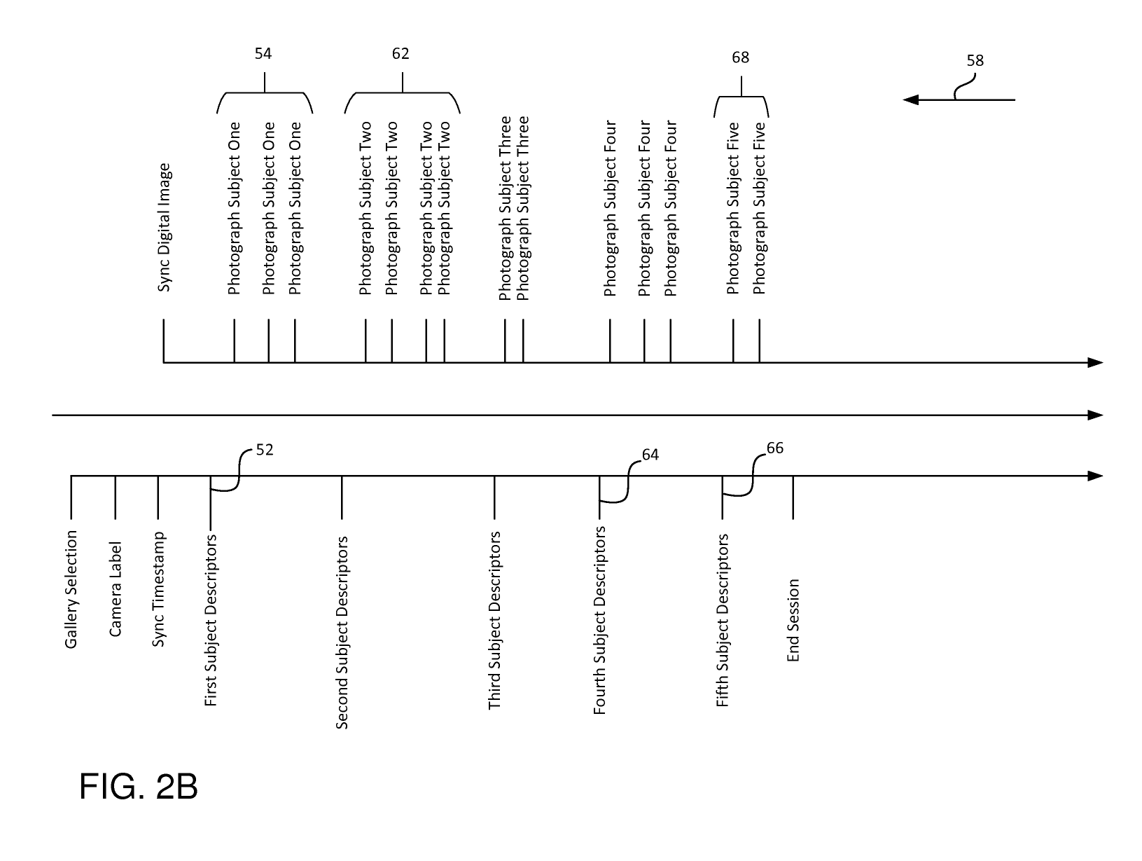

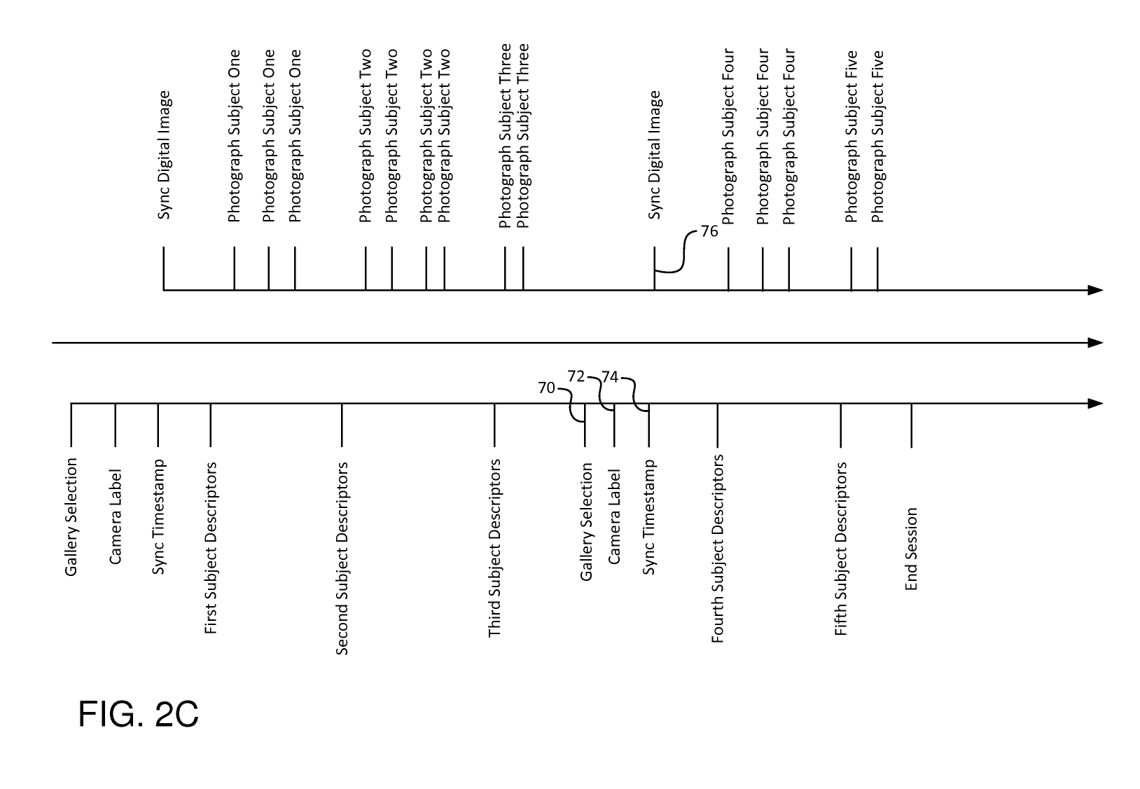

Referring to FIG. 2A, the relationship between the physical representation of the physical activities of the photographer for recording the physical actions taken at the physical location of the photo-shoot and the images captured by the photographic subject is shown. The passage of time is represented by the timeline 40. The physical steps taken by the photographer for organizing the photographic images is shown as the subject timeline 42 and the temporal relationship of the actual images is shown as the image timeline 44. When the photographer arrives at the photo-shoot, the photographer selects a particular gallery at 46. In one embodiment, a list of galleries is retrieved from the server and displayed to the photographer so that the photographer can select the proper gallery. In one embodiment, the gallery information can be entered by the photographer in the event that the gallery information is not provided or otherwise not available.

At 48, the photograph selects the camera label. The camera label is a camera identifier that uniquely identifies a particular camera that is being used by the photographer. In some photo-shoots, there are multiple photographers taking images of photographic subjects that share the same gallery. For example, when shooting school photographs, the gallery may be for the entire school with different photographers shooting different images of students in different classes simultaneously. Once the camera label is selected, the photographer then actuates the smart phone application to capture the date and time stamp at 50a. Simultaneously, the photograph also takes a synchronization image 50b with the camera which results in an initial sync image having a date and time stamp. At 52, the photographer selects the first photographic subject to be photographed. At 54, the photographer takes one or more photographs of the first subject. It is also possible for the photographer to select the second subject without taking photographs of the first subject in the event of an absent photographic subject. In one embodiment, the subject descriptors are retrieved from the smart phone from the server and presented to the photographer for selection. This process can be repeated for multiple subjects. At 56, the photographer can indicate that the photograph session is completed. This indication is received by the smart phone and can be transmitted either in real time or subsequent to the photo-shoot to the server along with the gallery selection, camera label, sync timestamp and subject indicators. The set of images, including the synchronization image, can be transmitted to the server.

Once the information above is transmitted to the server, the photographer, or other individual, can review the information and have the sync timestamp and sync image date and time information displayed. A delta can be calculated between the sync timestamp and the sync image date and time information. Using this delta, the date and time information of the sync image and the digital images themselves can be adjusted and aligned with the date and time information of the subject matter identifiers.

Referring to FIG. 2B, the image timeline is shown shifted in a temporal direction 58 along the timeline so that the sync timestamp of the subject timeline aligns with the sync image of the image timeline. Creating this physical relationship between the actions of the photographer in selecting subject descriptor and capturing the image of the subject allows the subject descriptor to be associated with one or more images. In this example of the invention and process, the first subject descriptor is selected earlier in time than the captured first image. Therefore, it is known that the images 54 are associated with the subject descriptor 52. It is also known that the images are associated with a particular gallery. When the photographer selects the second subject descriptor 60, it is known that the images 62 are associated with the second subject descriptor as they fall between the date and time stamp of the second subject descriptor and the third subject descriptor.

According to this invention, the functionality of the service is improved in that the captured digital images can be associated with a subject descriptor even when the date and time information of the smart phone is not sync'd with the date and time of the server or camera. Further, field of associating digital images with galleries and subject matter identifier is improved and reduces the time and energy expended in an attempt to match subject matter identifier with captured digital images.

According to the present invention, it is not necessary for the photographic subjects to be in a certain order nor it is necessary to capture all the images in a linear fashion. For example, at 64, the photographer indicates that the fourth subject is the next set of images to capture. However, the subject is absent or otherwise not available for photographs. Therefore, the photographer selects the fifth subject at 66 and the images 68 can be associated with this subject.

Referring to FIG. 2C, the flexibility and error correcting aspects that improve the current start of the art and technological field is shown. In the event a camera ceases to be operational, such as after the third subject is photographed in this example, the photographer can obtain a new camera, select the gallery at 70, select a camera label for the new camera at 72, capture a second sync timeline at 74 and take second sync image at 76 and continue to photograph subjects.

In one embodiment, the sync image is an image taken with the lens cap on so that image is clack or near black. The server computer readable instructions can then determine that the black or near black image is the a sync image.

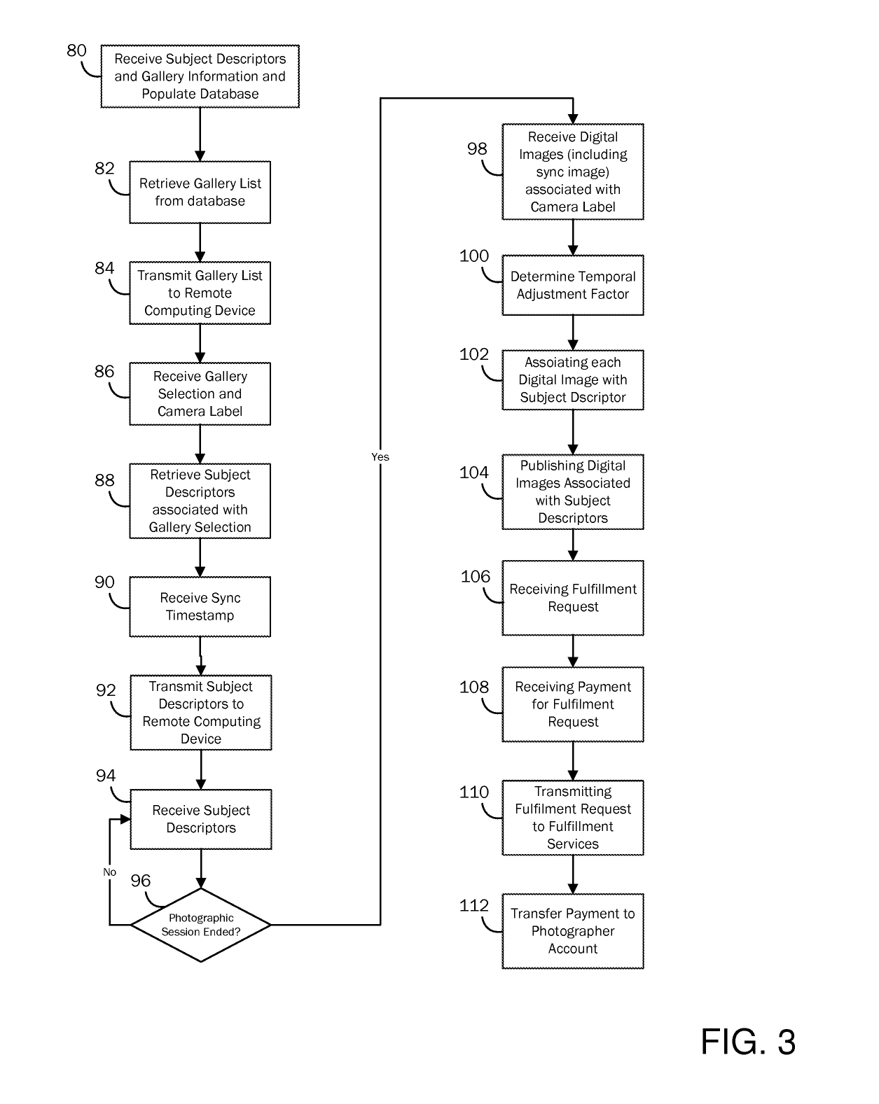

Referring to FIG. 3, the process and functionality of the server that illustrates the invention adds substantially more than the operation of the general computer and above and beyond conventional computer operations. Further, the technology in the field of matching images with subject matter identification is improved and the traditional problem of efficiently and automatically associated images with subject information has been solved. At 80, the list of subject descriptors and the associated gallery is placed in a database as it is received from a source such as a school. When the photographer wishes to start taking photos of subject, the remote computing device, such as a smart phone with an app, the photographer requests the gallery list from the server at 82 and it is transmitted at 84. The gallery list is displayed to the photographer at 86 so that the photographer can select the gallery that the photographer wishes to work with at 86. The camera label, identifying the camera to be used, is captured by the remote computing device at 86 as well. The server then retrieves the subject descriptors associated with the selected gallery at 88. The photographer then creates a sync timestamp at 90. The subject descriptors are transmitted to the remote computer device from the server at 92 and displayed on the remote computer device. The photographer indicates using the remote computer device that the first subject descriptors will be the subject of the next digital images. When the images are taken of the first subject, the photographer selects the next subject descriptor and takes images of that subject. The subject descriptors selected by the photographer can be transmitted to the server at 94 real time or can be transmitted in a batch after the photographic session is completed. If more subject matter descriptors exist at 96, the invention returns to 94 otherwise the invention continues where the digital images are uploaded to the server at 98.

The temporal adjustment factor is calculated at 100. Using the adjustment factor on the timestamps of each digital image, the images are associated with the proper subject descriptor at 102. The images are then published for review such as on a website of the global communication network at 104.

The server can receive a request for fulfillment at 106 and payment for the fulfillment request at 108. The digital image selected can be transmitted to a fulfillment service at 110 and payment can be transferred to the photographer at 112. Notifications can alert each individual, using the individual's contact information that can be contained in the subject descriptors, at 104 when the images are published.

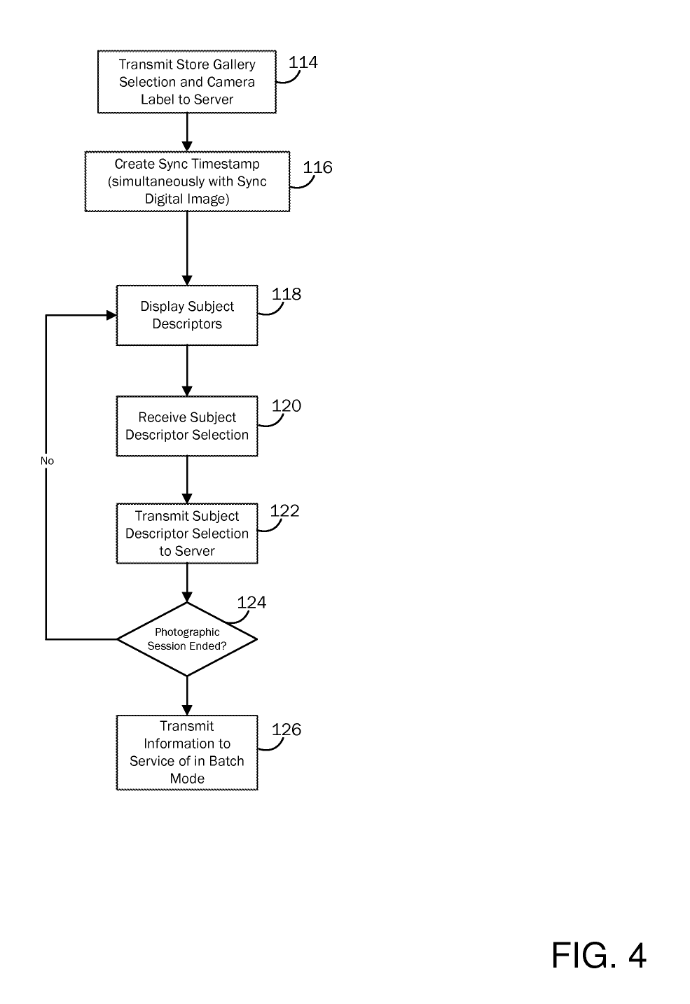

Referring to FIG. 4, the remote computer device (smart phone in one case), transfers the camera label and gallery selection to the server at 114. A sync timestamp is created at 116 that can be performed simultaneously with the creation of a sync digital image. The subject descriptor can be selected at 120 after being displayed at 118 and once selected can be transmitted to the server at 122. If additional subject descriptors remain at 124, the invention can return to 118. If the gallery selection, camera label, sync timestamp and subject descriptors are transmitted in batch mode, it can occur at 126.

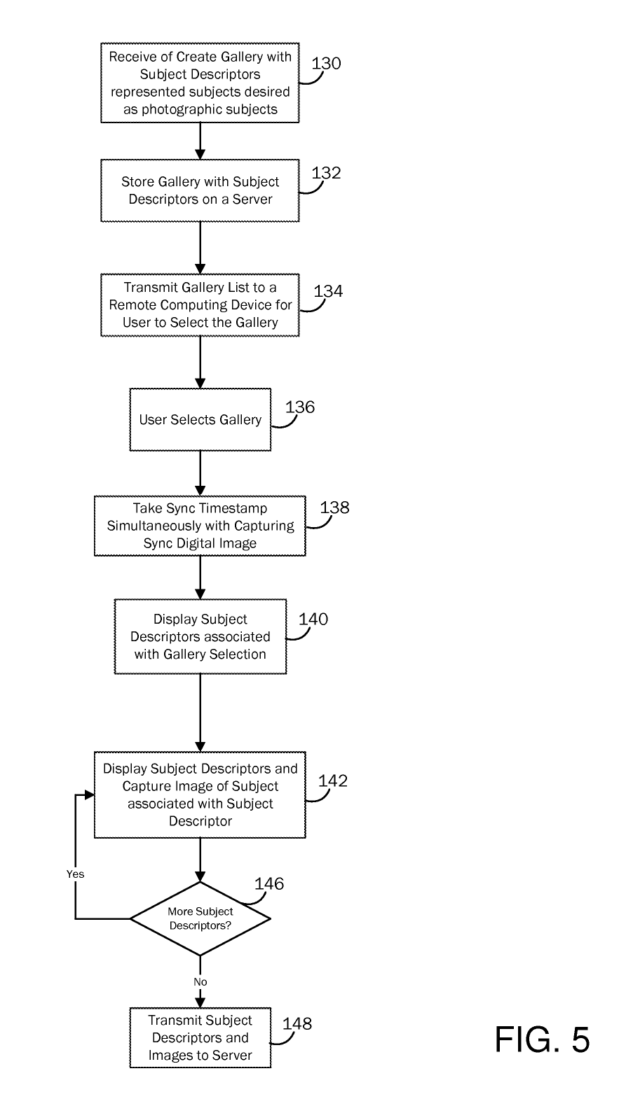

Referring to FIG. 5, the operation of the invention is shown in more detail and particularly how technology in the field of matching images with subject matter identification is improved. A gallery having subject descriptors is created at 130. This can be a list of students for school photographs, team members for a sports team, employee headshots for marketing collateral and the like. The gallery and the associated subject descriptors can be stored on a server at 132. A list of galleries can be transmitted to a remote computing device so that when the photographer selects the gallery, the selection can be transmitted back to the server and the list of subject descriptors that are associated with the gallery are transmitted to the remote computing device. In one embodiment, the remote computing device accesses the server through a web browser to have information from the server displayed to the user of the remote portable device such as through a URL. Once the list of galleries is displayed at 143, the photographer can select which gallery to work with at 136. Once the gallery is selected, a sync timestamp can be captured at 138 and the list of subject descriptors is displayed for the photographer at 140. Images are then captured for the selected subject descriptor at 142. If there are more subject descriptors in the list at 146, the invention returns to 144, otherwise, the subject descriptions, digital images and other information is transmitted to the server at 148.

What is claimed is:

1. A system for associating digital images with digital image subjects comprising:
a server having a server computer readable medium and processor that can have electronic communications with a portable computing device and a digital camera media;
a subject database having a set of subject descriptors stored on the server computer readable medium wherein each subject descriptor represents a unique subject to be photographed; and,
a set of server computer readable instructions stored on the service computer readable medium that when executed by the server's processor receives the set of subject descriptors from a remote computer system, populates the subject database with the list of subject descriptors, associates a gallery identifier with the set of subject descriptors, transmits a list of gallery identifiers, each associated with a list of subject descriptors, to the portable computing device, receives a gallery identifier selection from the portable computing device, transmits the set of subject descriptors from the subject database to the portable computing device that are associated with the selected gallery identifier, receives a sync timestamp from the portable computing device, receives a plurality of subject descriptors each having a timestamp, receives a sync digital image from the digital camera media having a digital image sync timestamp wherein the sync timestamp and the sync digital image are created contemporaneously, receives a set of images from the digital camera media wherein each image includes a timestamp, determines a temporal adjustment factor representing the difference between the sync timestamp and the timestamp of the sync digital image and associates a digital image with a first subject descriptor if the adjusted timestamp of the digital image falls between the timestamp of the first subject descriptor and a second subject descriptor.

2. The system of claim 1 wherein the set of server computer readable instructions includes instructions that receives a camera label from the portable computing device.

3. The system of claim 2 wherein the set of server computer readable instructions include instructions for starting a new session upon receiving a request from a remote portable computing session, associating the camera label with the session, associating the sync timestamp with the session, associating the set of subject descriptors with the session and associating the digital images with the session.

4. The system of claim 1 wherein the server receives the plurality of subject descriptors, each having a timestamp, in a linear fashion and in real time.

5. The system of claim 1 wherein the set of server computer readable instructions includes instructions that display a portion of the invention from each subject descriptor and the associated digital images on a website accessible through a global communications network.

6. The system of claim 5 wherein the set of server computer readable instructions includes instructions for receiving image selection information from a user accessing the website identifying a digital image and transmitting the digital image to a print fulfillment service so that the use can be provided a physical copy of the digital image.

7. The system of claim 5 wherein the set of server computer readable instructions includes instructions for displaying the subject descriptors organized by gallery identifiers.

8. The system of claim 1 wherein the set of server computer readable instructions includes instructions for receiving a camera label and associating the camera label with a gallery.

9. The system of claim 1 wherein:
the sync digital image is an image taken with the lens cap on providing for a black image, and,
the set of server computer readable instructions includes instructions for identifying a black digital image as the sync digital image.

10. A system for associated digital images with digital image subjects comprising:
a personal computing device in wireless communications with a server that, when actuated by a photographer, receives gallery selection input, captures a sync timestamp and receives a plurality of subject descriptor inputs wherein each subject descriptor input has a unique timestamp;
a digital camera for capturing a plurality of digital images, including a sync digital image, each having a timestamp; and,
a server having computer readable instructions stored in the server for receiving the digital images, receiving the sync timestamp, determining an adjustment factor representing the difference between the sync timestamp and the timestamp of the sync digital image, adjusting the timestamp of a digital image by the adjustment factor, and associating the digital image with a first subject descriptor when the adjusted timestamp of the digital image falls between the time stamp of a first subject descriptor and a second subject descriptor.

11. The system of claim 10 wherein the capturing of the sync timestamp occurs simultaneously with the taking of the sync digital image.

12. The system of claim 10 wherein the computer readable instructions of the server includes instructions for displaying a portion of the invention from each subject descriptor and the associated digital images on a website accessible through a global communications network and receiving image selection information from a user accessing the website, identifying a digital image and transmitting the digital image to a print fulfillment service so that the user can be provided a physical copy of the digital image.

13. The system of claim 10 wherein the personal computing device transmits the gallery selection input, sync timestamp and plurality of subject descriptor inputs to the server in real time.

14. The system of claim 10 wherein the personal computing device stores the gallery selection input, sync timestamp and plurality of subject descriptor inputs on the personal computing device until a photographic session is completed.

15. The system of claim 14 wherein the personal computing device transmits the stored gallery selection input, sync timestamp and plurality of subject descriptor inputs to the server once the photographic session is completed and prior to the server receiving the digital images.

16. A system for associated digital images with digital image subjects comprising:
a personal computing device having computer readable instructions so that when the personal computing device is actuated by a photographer, the personal computing device displays at least one gallery receiving a gallery selection input, receives a camera label, captures a sync timestamp, displays a plurality of subject descriptors, receives a subject descriptor input, wherein each subject descriptor input has a unique timestamp, and transmits the gallery selection input, camera label, sync timestamp and plurality of subject descriptors to a server;
a digital camera for capturing a plurality of digital images, including a sync digital image, each having a timestamp that can be uploaded to the server; and,
a set of server computer readable instructions stored on the server for: receiving the gallery selection input, camera label and sync timestamp, receiving the digital images, determining an adjustment factor representing the difference between the sync timestamp and the timestamp of the sync digital image, adjusting the timestamp of a digital image by the adjustment factor, associating the digital image with a first subject descriptor when the adjusted timestamp of the digital image falls between the time stamp of a first subject descriptor and a second subject descriptor, displaying a portion of information from each subject descriptor, displaying the digital images associated with the subject descriptor on a website accessible through a global communications network, receiving image selection information from a user accessing the website identifying a digital image and transmitting the digital image to a print fulfillment service so that the use can be provided a physical copy of the digital image.

17. The system of claim 16 wherein the set of server computer readable instructions stored on the server for verifying that payment has been made for the print prior to transmitting the digital image to the print fulfillment center.

18. The system of claim 16 wherein the capturing of the sync timestamp occurs simultaneously with the taking of the sync digital image.

19. The system of claim 16 wherein:
the sync digital image is an image taken with the lens cap on, providing for a near black image, and,
the set of server computer readable instructions includes instructions for identifying the near black digital image as the sync digital image.

20. The system of claim 16 wherein contact information is included in the subject descriptor and the set of server computer readable instructions includes instructions for transmitting a notification to an individual associated with the contact information informing the individual that the digital images are available for viewing and physical goods having the image can be requested.

21. The system of claim 20 wherein the set of server computer readable instructions includes instructions for transmitting a notification to an individual associated with the contact information informing the individual that the physical goods have been created.

22. A system for associating digital images with digital image subjects comprising:
a server having a server computer readable medium and processor that can have electronic communications with a portable computing device and a digital camera media; and,
a set of server computer readable instructions stored on the service computer readable medium that when executed by the server's processor receives a gallery identifier selection from the portable computing device, receives a sync timestamp from the portable computing device, receives a sync digital image from the digital camera media having a digital image sync timestamp wherein the sync timestamp and the sync digital image are created contemporaneously, receives a plurality of subject descriptors each having a timestamp, receives a set of images from the digital camera media wherein each image includes a timestamp, determines a temporal adjustment factor representing the difference between the sync timestamp and the timestamp of the sync digital image and associates a digital image with a first subject descriptor if the adjusted timestamp of the digital image falls between the timestamp of the first subject descriptor and a second subject descriptor.
